(19) United States
(12) Patent Application Publication
(10) Pub. No.: US 2010/0162134 A1
(43) Pub. Date: Jun. 24, 2010

(54) DISPLAY DEVICE CAPABLE OF BEING REMOTELY SET DESKTOP BACKGROUND AND METHOD THEREOF

(75) Inventors: CHUAN-HONG WANG, Tu-Cheng (TW); HSIAO-CHUNG CHOU, Tu-Cheng (TW); LI-ZHANG HUANG, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/465,604

(22) Filed: May 13, 2009

(30) Foreign Application Priority Data
Dec. 18, 2008 (CN) 200810306355.8

(51) Int. Cl. G06F 3/048; G06F 15/16

(52) U.S. Cl. 715/752

(57) ABSTRACT

A method for remotely setting desktop background of a display device, wherein the display device accesses and receives emails from an email account, the method comprising: reading a received email; detecting whether the parameters of the read email are consistent with the predetermined rules; detecting whether properties of the comprised image are consistent with predetermined properties if the parameters of the read email are consistent with the predetermined rules; setting the image as a desktop background of the display device if the properties of the image are consistent with predetermined properties; storing the set desktop background. A display device capable of being remotely set desktop background is also provided.

### BACKGROUND

1. Technical Field

The present disclosure relates to a display device capable of being remotely set desktop background and a method thereof.

2. Description of Related Art

In general, a desktop background of one display device can be changed by a user. However, the user with the display device cannot authorize other users to remotely change the desktop background of the display device. Accordingly, It results in a desktop background without surprise for the user.

Therefore, what is needed is a display device capable of being remotely set desktop background and a method thereof.

### BRIEF DESCRIPTION OF THE DRAWINGS

FIG. 1 is a schematic diagram of an email receiving system, including a display device with email function, in accordance with an exemplary embodiment.

FIG. 2 is a block diagram of a hardware infrastructure of the display device of FIG. 1 in accordance with an exemplary embodiment.

FIG. 3 is a flowchart of a method for remotely setting desktop background of the display device in accordance with an exemplary embodiment.

### DETAILED DESCRIPTION

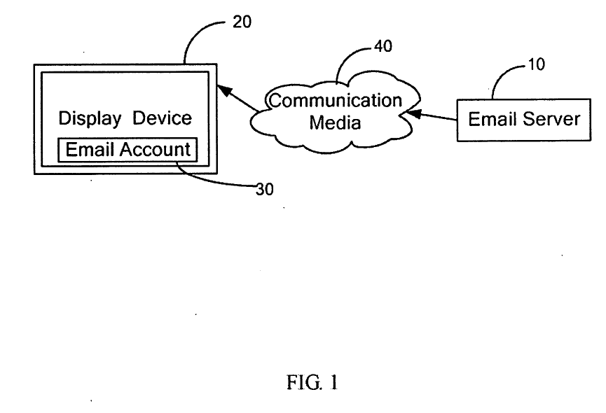

FIG. 1 is a schematic diagram of an email receiving system in accordance with an exemplary embodiment. The system includes a display device 20, an email server 10, and a communication media 40. The display device 20 includes an email program and an associated memory for storage of received emails. The display device 20 is connected to the email server 10 via the communication media 40, for example, a network (e.g., the Internet, a local network, a local area network, or a wireless network). The display device 20 is configured to access and receive emails from an email account 30 by logging into the email server 10 via the communication media 40, and acquire an image from the received emails to set a desktop background. Changing of the desktop background of the display device 20 is described below.

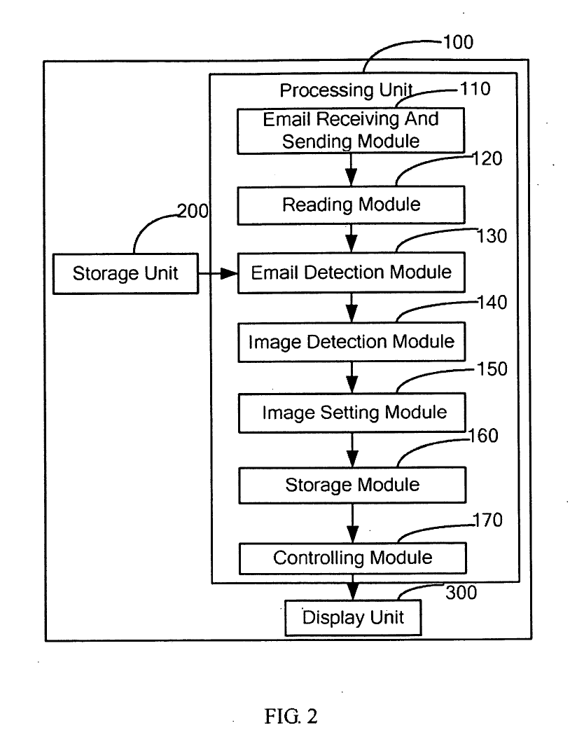

FIG. 2 is a block diagram of a hardware infrastructure of the display device of FIG. 1 in accordance with an exemplary embodiment. The display device 20 includes a processing unit 100, a storage unit 200, and a display unit 300. The storage unit 200 is configured to store the received emails.

The processing unit 100 includes an email receiving and sending module 110, a reading module 120, an email detection module 130, an image detection module 140, an image setting module 150, a storage module 160, and a controlling module 170. The email receiving and sending module 110 is configured to receive and send emails via the email account 30. The reading module 120 is configured to read the received emails.

The email detection module 130 is configured to detect whether parameters of the read email are consistent with predetermined rules. The parameters can be, but are not limited to, a sender's email address, an email subject, and email content, and so on. The predetermined rules can be pre-stored in the storage unit 200, or can be set in an implementation process of the email detection module 130. In the exemplary embodiment, the predetermined rules are that the email subject and/or email content of the read email include a verification code and the read email includes an image. The verification code can be a predetermined code or an identification code (ID) of the display device 20. In the exemplary embodiment, the email detection module 130 detects whether the email subject and/or email content of the read email includes the verification code and the read email includes an image to determine whether the parameters of the read email are consistent with the predetermined rules. If the email subject and/or email content of the read email includes the verification code and the read email includes an image, the email detection module 130 determines that the parameters of the read email are consistent with the predetermined rules. Otherwise, the parameters of the read email are not consistent with the predetermined rules; the processing unit 100 processes the read email in a general manner. In the exemplary embodiment, the general manner can be, but is not limited to, storing the email, displaying the email, and so on.

In another exemplary embodiment, the predetermined rules can be: the email subject and/or email content of the read email includes a predetermined keyword and the read email includes an image. The email detection module 130 detects whether the email subject and/or email content of the read email includes the predetermined keyword and the read email includes an image to determine whether the parameters of the read email are consistent with the predetermined rules.

The image detection module 140 is configured to detect whether properties of the included image are consistent with predetermined properties if the parameters of the read email are consistent with the predetermined rules. The predetermined properties of the image can be stored in the storage unit 200, or in an implementation process of the image detection module 140. In the exemplary embodiment, the properties can be, but are not limited to, an image size, an image format, an image resolution, and so on.

The image setting module 150 is configured to set the image of the read email as a desktop background of the display device 20 if the properties of the image are consistent with the predetermined properties. The image setting module 150 is configured to further edit the image until the properties of the image are consistent with the predetermined properties if the properties of the image are not consistent with the predetermined properties, and set the edited image as the desktop background of the display device 20. In other embodiments, the image setting module 150 does not edit or set the image of the email as the desktop background of the display device 20 if the properties of the image are not consistent with the predetermined properties.

The storage module 160 is configured to store the set desktop background of the display device 20 in the storage unit 200.

The controlling module 170 is configured to display the set desktop background of the display device 20 on the display unit 300, either immediately or when the display device 20 is restarted.

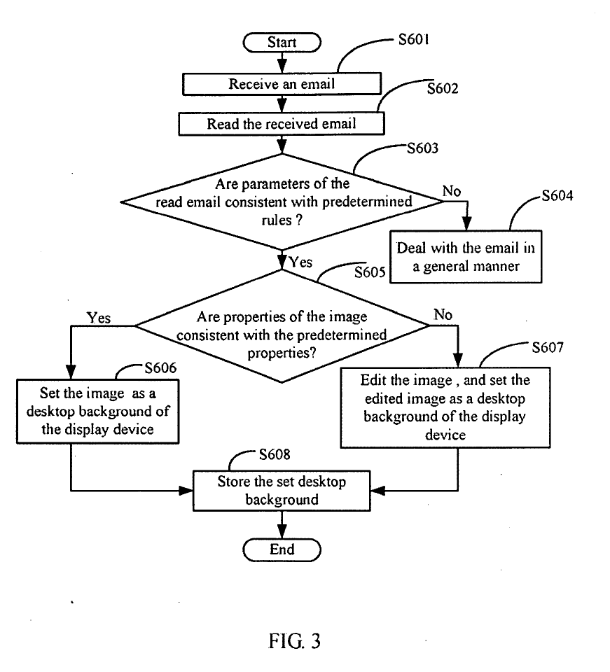

FIG. 3 is a flowchart of a method for remotely setting a desktop background of the display device in accordance with an exemplary embodiment.

In step S601, the email receiving and sending module 110 receives an email via the email account 30 of the display device 20.

In step S602, the reading module 120 reads the received email.

In step S603, the email detection module 130 detects whether parameters of the read email are consistent with the predetermined rules, if no, go to step S604, if yes, go to step S605.

In step S604, the processing unit 100 deals with the read email in a general manner.

In step S605, the image detection module 140 detects whether properties of the included image are consistent with predetermined properties, if yes, go to step S606, if no, go to step S607.

In step S606, the image setting module 150 sets the image of the read email as a desktop background of the display device.

In step S607, the image setting module 150 edits the image until the properties of the image are consistent with the predetermined properties, and sets the edited image as the desktop background of the display device 20. In another exemplary embodiment, the image setting module 150 does not edit or set the image of the email as the desktop background of the display device if the properties of the image are not consistent with the predetermined properties.

In step S608, the storage module 160 stores the set desktop background of the display device in the storage unit 200 and the process ends.

In one embodiment the new desktop background image will be immediately displayed by the controlling module 170, in another embodiment the controlling module 170 displays the set desktop background on the display unit 300, when the display device is restarted.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A display device capable of being remotely set a desktop background, wherein the display device accesses and receives emails from an email account, the display device comprising:
a storage unit capable of storing the received emails;
a display unit;
a processing unit comprising:
an email receiving and sending module capable of receiving and sending emails via the email account of the display device;
a reading module capable of reading a received email;
an email detection module capable of detecting whether parameters of the read email are consistent with predetermined rules;
an image detection module capable of detecting whether properties of image included in the read email are consistent with predetermined properties if the parameters of the read email are consistent with predetermined rules;
an image setting module capable of setting the image as a desktop background of the display device if the properties of the image are consistent with predetermined properties;
a storage module capable of storing the set desktop background of the display device in the storage unit;
a controlling module capable of displaying the set desktop background on the display unit.

2. The display device as in claim 1, wherein the email detection module is capable of detecting whether an email subject and/or email content of the read email comprises a verification code and the read email includes an image to determine whether the parameters of the read email are consistent with predetermined rules.

3. The display device as in claim 1, wherein the email detection module is further capable of detecting whether an email subject and/or email content of the read email comprises a predetermined keyword and the read email includes an image to determine whether the parameters of the read email are consistent with predetermined rules.

4. The display device as claim 2, wherein the verification code is a predetermined code or an identification code (ID) of the display device.

5. The display device as claim 1, wherein the image setting module is further capable of editing the image until the properties of the image are consistent with the predetermined properties if the properties of the image are not consistent with the predetermined properties, and setting the edited image as a desktop background of the display device.

6. The display device as claim 1, wherein the controlling module is capable of displaying the set desktop background when the display device is started.

7. The display device as claim 1, wherein the controlling module is capable of displaying the set desktop background immediately after it is set.

8. A method for remotely setting desktop background of a display device, wherein the display device accesses and receives emails from an email account, the method comprising:
reading a received email;
detecting whether the parameters of the read email are consistent with the predetermined rules;
detecting whether properties of the comprised image are consistent with predetermined properties if the parameters of the read email are consistent with the predetermined rules;
setting the image as a desktop background of the display device if the properties of the image are consistent with predetermined properties; and
storing the set desktop background.

9. The method as described in claim 8, wherein the email detecting step further comprising:
detecting whether an email subject and/or email content of the read email comprises a verification code and the read email includes an image to determine whether the parameters of the read email are consistent with predetermined rules.

10. The method as described in claim 8, wherein the email detecting step further comprising:
detecting whether an email subject and/or email content of the read email comprises a predetermined keyword and the read email includes an image to determine whether the parameters of the read email are consistent with predetermined rules.

11. The method as described in claim 8, wherein the verification code is a predetermined code or an identification code (ID) of the display device.

12. The method as described in claim 8, wherein the image detecting step further comprising:
editing the image until the properties of the image are consistent with the predetermined properties if the properties of the image are not consistent with the predetermined properties, and setting the edited image as the desktop background of the display device.

13. The method as described in claim 8, further comprising displaying the set desktop background when the display device is started.

14. The method as described in claim 8, further comprising displaying the set desktop background immediately after it is set.
